(19) United States
(12) Patent Application Publication
(10) Pub. No.: US 2005/0223464 A1
(43) Pub. Date: Oct. 13, 2005

(54) Luminescent vest equipped with plastic optical fibers

(76) Inventors: Jyh-Perng Huang, Hsin-Chu City (TW); Chien-Tang Wang, Hsin-Chu City (TW)

Correspondence Address: J.C. Patents, Suite 250, 4 Venture, Irvine, CA, 92618, US

(21) Appl. No.: 10/820,830

(22) Filed: Apr. 7, 2004

(51) Int. Cl. G02B 6/22; G02B 6/02; A41D 1/04

(52) U.S. Cl. 2/102

(57) ABSTRACT

A luminescent vest equipped with plastic optical fibers having structural layers including a top layer of plastic film, a middle layer of plastic optical fibers and a bottom layer of a web-like structure. The middle woven layer has the following woven structure: (1) interwoven by lengthwise plastic optical fibers and crosswise plastic optical fibers; (2) interwoven by crosswise chemical fibers and lengthwise plastic optical fibers; (3) interwoven by lengthwise chemical fibers and crosswise plastic optical fibers. The three-layer structure is distributed at appropriate positions on the vest, while the top part of plastic film layer is arranged with letters or patterns serving to project light from the plastic optical fibers, and connected to electrical power to project alarm light effects. The present invention can be used in applications that include a traffic policeman's uniform, an environmental protection worker's uniform, a security guard's uniform and ordinary apparel.

### 1. FIELD OF THE INVENTION

The present invention relates to a luminescent vest equipped with plastic optical fibers, particularly to a luminescent vest equipped with a middle layer of light-emitting woven fabric, to attract people's attention and ensure better safety.

### 2. BACKGROUND OF THE INVENTION

With the increase of traffic flow, people on the road like road workers, traffic policemen, road sweepers and ordinary pedestrians, need better protection by wearing a luminescent vest, especially at night when motorists can not see very well. Without a luminescent vest at night, joggers or pedestrians may face the danger of a traffic accident. For this reason, there is a readily available vest on the market, which is equipped with light-reflecting strips that reflect light only when there is a light source projected onto the vest. Yet, this type of vest does not emit light by itself. The motorist cannot see the person wearing the vest until the car is within a very short distance from the vest wearer. That could be a recipe for disaster, causing an accident and potential casualty due to a lack of alarm. There is another vest on the market that attempts to solve this problem with LED devices. But such light-emitting diodes have a risk of burning out and the shortcoming of higher costs.

### 3. SUMMARY OF THE INVENTION

It is the objective of this invention to provide a luminescent vest equipped with plastic optical fibers, installed with luminescent woven layers at specified locations on the back and front of the vest, and consisting of three structural layers. The top layer is a plastic film that has letters or patterns on the surface that project light. The middle layer is a woven layer, including (1) plastic optical fibers woven lengthwise and chemical fibers woven crosswise; (2) plastic optical fibers woven crosswise and chemical fibers woven lengthwise; and (3) plastic optical fibers woven lengthwise and crosswise. The bottom layer is a web-like woven layer. The aforementioned vest has three structural layers, where light is emitted for alarm effects. The present invention has the following features: (1) the lighting is made from plastic optical fibers that consume low power without generating heat, so they can be safety attached to woven fabrics; (2) the present invention is suitable for mass production at low cost.

It is another objective of the present invention to combine with all types of woven fabrics for extensive applications in a wide variety of products.

### 4. DESCRIPTION OF DRAWINGS

In order that the present invention may more readily be understood, the following description is given, merely by way of example with reference to the accompanying drawings, in which,

FIG. 1 is a schematic view of the woven layer of the present invention.

FIG. 2 is a second schematic view of the woven layer of the invention.

FIG. 3 is a third schematic view of the woven layer of the invention.

FIG. 4 is a schematic view of the present invention in which the plastic optical fibers are joined to the light-emitting units.

FIG. 5 is a view of the three structural layers of the invention.

FIG. 6 is a schematic view of the front side of the vest.

FIG. 7 is a schematic view of the rear side of the vest.

FIG. 8 is the invention of vest in application.

### 5. DESCRIPTION OF PREFERRED EMBODIMENT

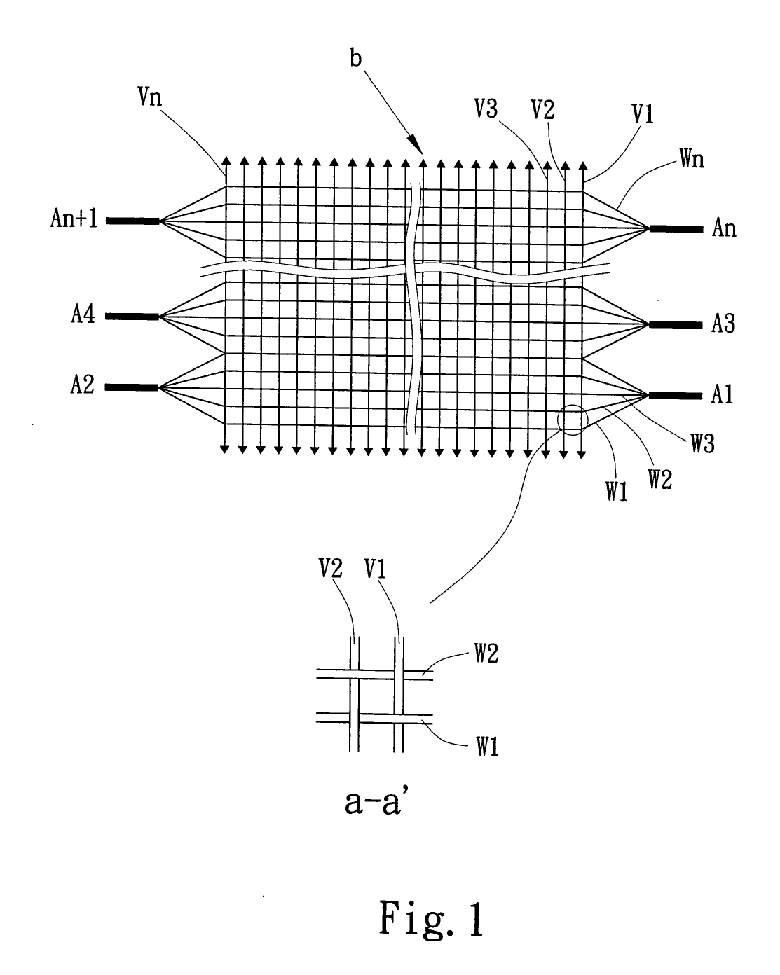

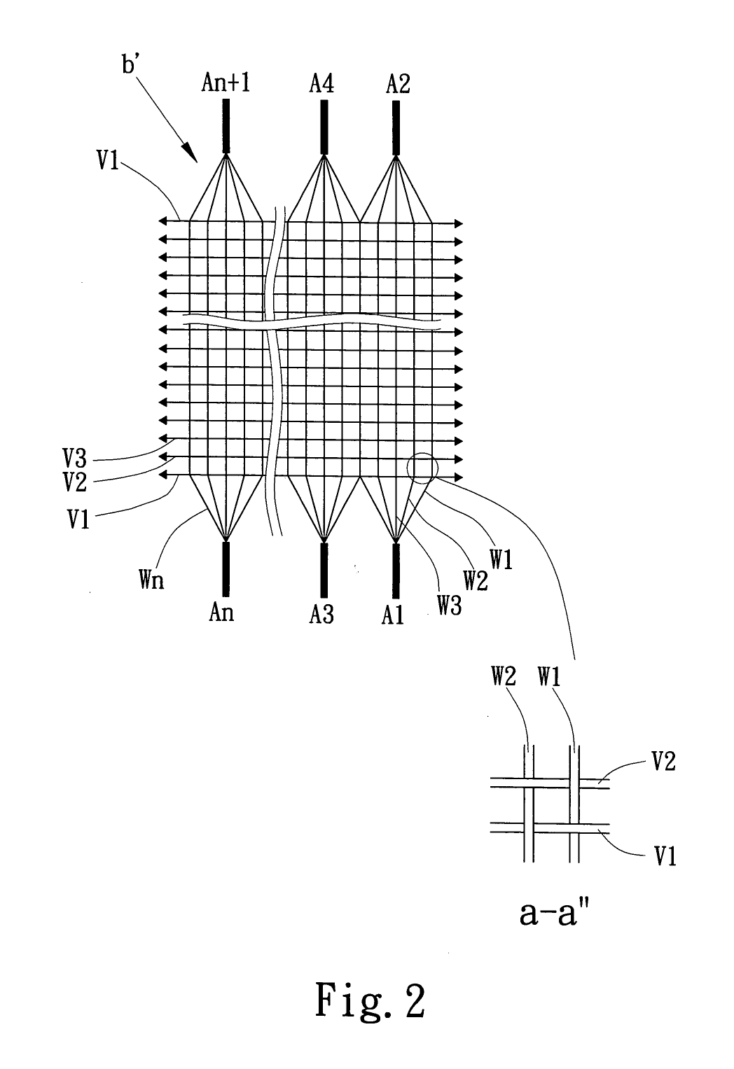

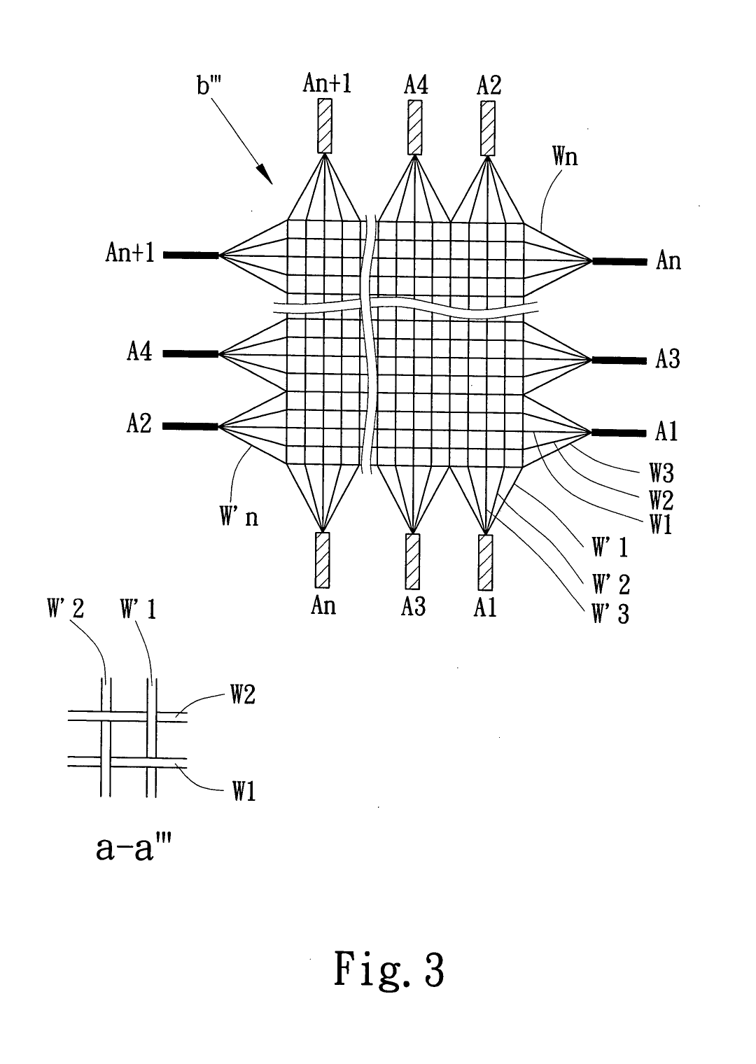

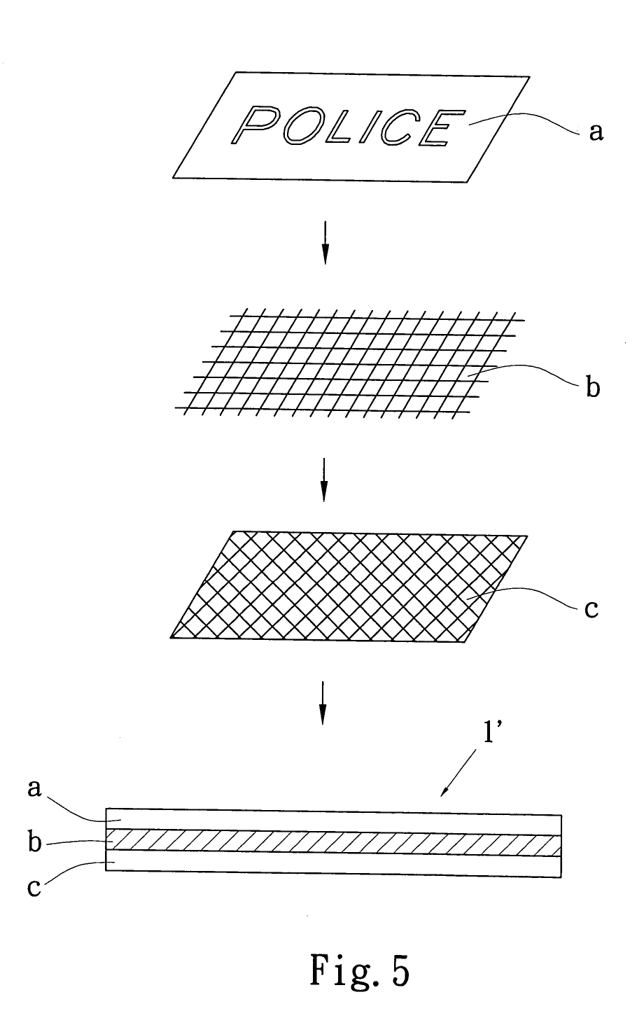

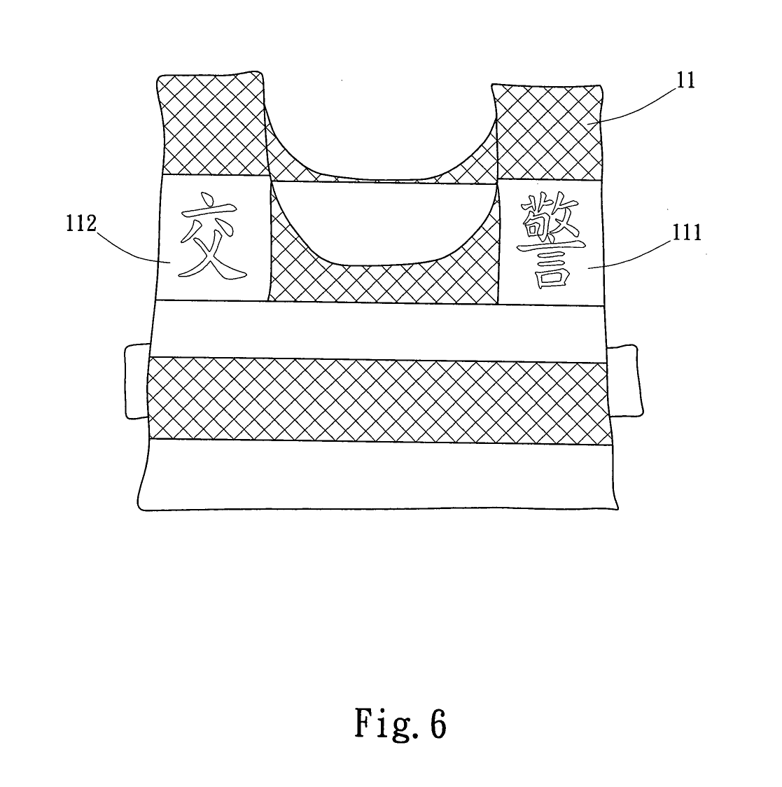

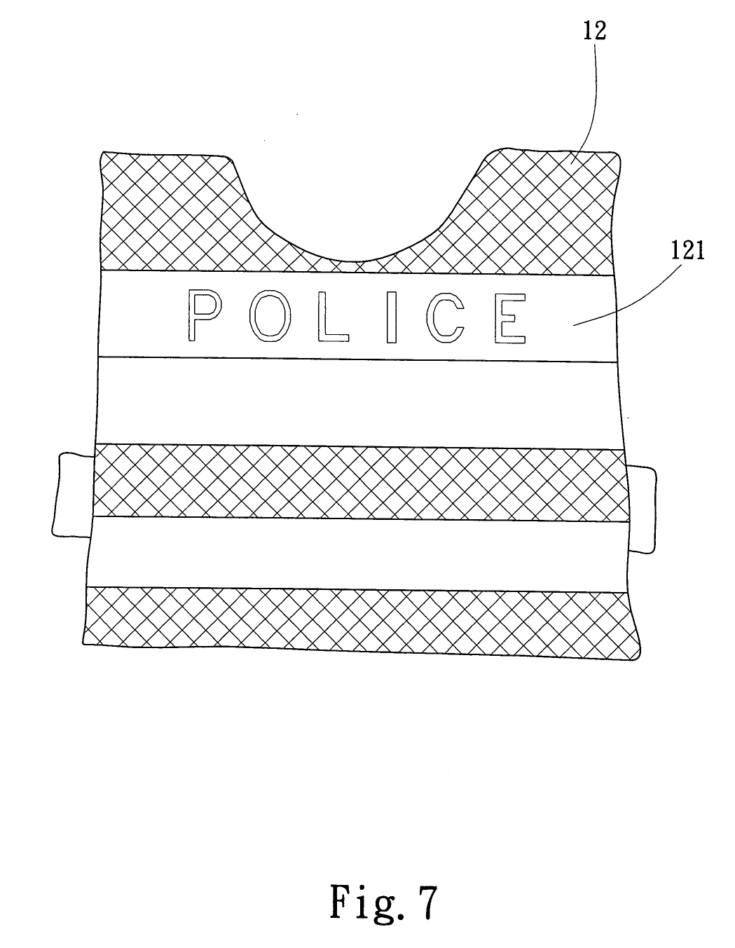

As shown in the drawings, the present invention is a vest equipped with luminescent plastic optical fibers. The vest 1 has a front side 11 and a rear side 12, wherein the front side 11 has light-emitting units 111 and 112, and the rear side 12 has a light-emitting unit 121, as shown in FIGS. 6 and 7. The light-emitting units 111, 112, 121 on the front side 11 and the rear side 12 are three structural layers: top layer, middle layer and bottom layer, as shown in FIG. 5. They include the top layer which is a plastic film layer a, made of PP, PVC, PET or any highly transparent plastic films, adhered to the woven layer b in the middle layer. On the surface of the plastic film layer a are letters or patterns according to design. The letters or patterns are transparent, serving to emit light. The middle layer of woven layer b includes: (1) the middle layer of woven layer b consisting of plastic optical fibers W1, W2, W3 . . . and Wn running lengthwise and interwoven with chemical fibers V1, V2, V3 . . . and Vn running crosswise, wherein several plastic optical fibers W1, W2, W3 . . . and Wn form plastic optical fiber bundles A1, A2, A3 . . . and An, An+1, as shown in FIG. 1, wherein, as shown in the blow-up FIG. a-a′, the lengthwise plastic optical fiber W1 pulls through the upper side of the crosswise chemical fiber V1 and the lower side of the chemical fiber V2, the crosswise plastic optical fiber W2 pulls through the lower side of the crosswise chemical fiber V1 and the upper side of the chemical fiber V2, forming a woven layer b; (2) the crosswise plastic optical fibers W1, W2, W3 . . . and Wn and the lengthwise chemical fibers V1, V2, V3 . . . and Vn are interwoven to form a woven layer b′, wherein several plastic optical fibers W1,W2,W3 . . . and Wn form plastic optical fiber bundles A1,A2,A3 . . . An, An+1, as shown in FIG. 2, wherein the chemical fibers V1,V2,V3 . . . Vn serve to fix in place the plastic optical fibers W1,W2,W3 . . . Wn, wherein, as shown in the blow-up FIG. a-a″, the lengthwise chemical fiber V1 pulls through the upper side of the plastic optical fiber W1 and the lower side of plastic optical fiber W2, and the lengthwise chemical fiber V2 pulls through the lower side of the plastic optical fiber W1 and the upper side of the plastic optical fiber W2, forming a woven layer b′; (3) the lengthwise plastic optical fibers W1,W2,W3 . . . Wn and the plastic optical fibers W′1,W′2,W′3 . . . W′n are interwoven to form a woven layer b′″, wherein, several plastic optical fibers W1,W2,W3 . . . Wn and plastic optical fibers W′1,W′2,W′3 . . . W′n form plastic optical fiber bundles A1,A2,A3 . . . An,An+1, as shown in FIG. 3, and, as shown in the blow-up FIG. a-a′″, the lengthwise plastic optical fiber W1 pulls through the upper side of the plastic optical fiber W′1 and the lower side of the plastic optical fiber W′2, and the lengthwise plastic optical fiber W2 pulls through the lower side of the crosswise plastic optical fiber W′1 and the upper side of the plastic optical fiber W′2, forming a woven layer b′″. The bottom layer is a web-like woven layer c.

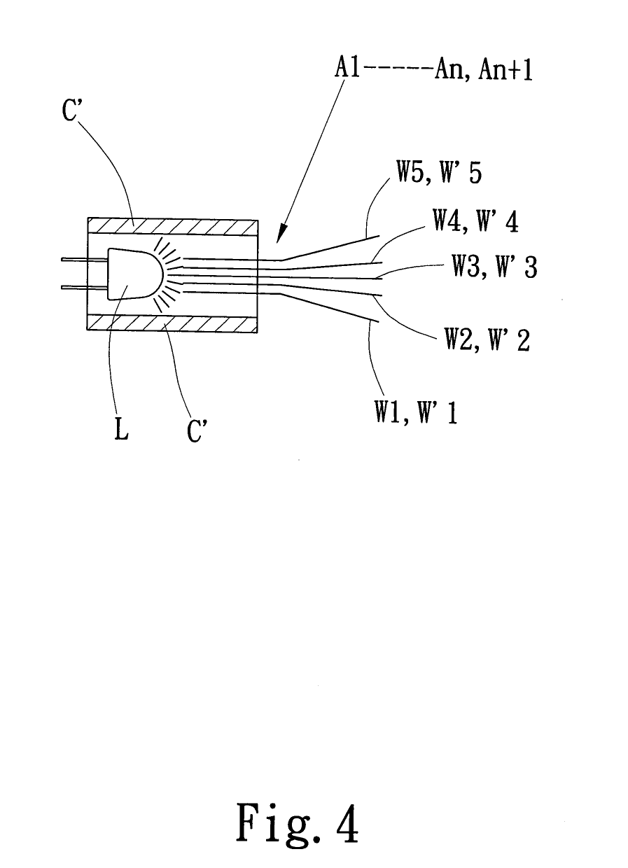

As shown in FIG. 4, the aforementioned plastic optical fiber bundles A1 . . . An,An+1 are mounted inside the plastic tube C′, then, when power is switched on, the light-emitting unit L projects light toward the plastic optical bundles A1 . . . An,An+1, so the plastic optical fibers W1,W′1,: W2,W′2, W3,W′3, W4,W′4, 5,W′5 project light. The three-layer structure 1′ shown in FIG. 5 consists of a surface layer of plastic film layer a, a middle layer of woven layer b, and a bottom layer of web-like woven layer c.

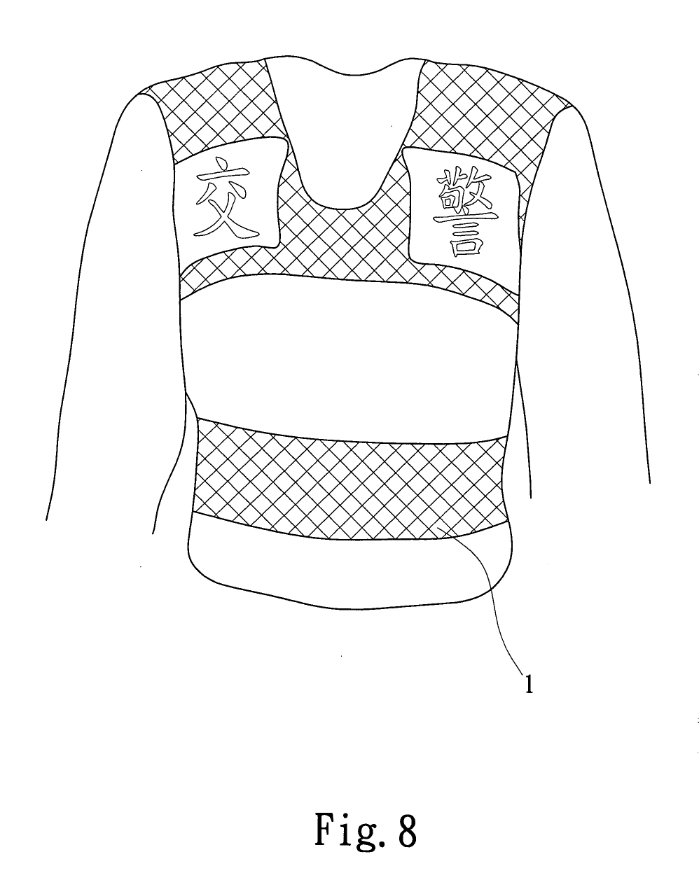

As shown in FIG. 6, the light-emitting units 111,112 on the front side 11 of the vest 1 is a three-layer structure 1′, as shown in FIG. 7, the light-emitting unit 121 on the rear side 12 of the vest 1 is also a three-layer structure 1′. Therefore, as shown in FIG. 8, the vest 1 worn on a user's body provides precautionary alarm and safety during nighttime.

The present invention of a luminescent vest that emits light from plastic optical fibers has the following characteristics:
(1) It provides precautionary effects when worn by a user at nighttime.
(2) It allows for extensive applications, including road sweepers, environmental protection workers, road workers and general pedestrians.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of the present invention.

1. A luminescent vest equipped with plastic optical fibers, comprising:
a top layer comprising a plastic film layer, having a transparent form, bearing letters or patterns according to preset designs;
a middle layer comprising a woven layer containing the plastic optical fibers, wherein a specified number of the plastic optical fibers form a bundle;
a bottom layer comprising a web-like woven layer;
wherein the top layer, the middle layer, and the bottom layer form a three-layer structure that is attachable to other clothing and products for extensive applications, including environmental protection uniforms, traffic policeman uniforms, road sweeping uniforms, security guard uniforms and general apparel, projecting light effects during nighttime for alarm effects.

2. The luminescent vest of claim 1, wherein the plastic optical fibers in the woven layer are lengthwise and crosswise.

3. The luminescent vest of claim 1, wherein the woven layer is interwoven by lengthwise plastic optical fibers and crosswise chemical fibers.

4. The luminescent vest of claim 1, wherein the woven layer is interwoven by crosswise plastic optical fibers and lengthwise chemical fibers.

5. The luminescent vest of claim 3, wherein the chemical fiber in the woven layer is made of polyester, nylon or blended fiber.

6. The luminescent vest of claim 1, wherein the plastic optical fiber bundle coupled to a light-emitting unit to guide and project light.

7. A luminescent vest comprising:
a transparent plastic film layer;
a woven layer containing plastic optical fibers, wherein a specified number of the plastic optical fibers form a bundle; and
a web-like woven layer;
wherein the woven layer is sandwiched between the transparent plastic film layer and the web-like woven layer forming a three layer structure, and the plastic optical fiber bundle is coupled to a light-emitting unit to guide and project light.
